(19) United States
(12) Patent Application Publication
(10) Pub. No.: US 2015/0282141 A1
(43) Pub. Date: Oct. 1, 2015

(54) WIRELESS LAN APPARATUS, WIRELESS LAN TERMINAL, AND CONTROL METHOD FOR THE SAME

(71) Applicant: NEC Platforms, Ltd., Kanagawa (JP)

(72) Inventor: Takuya YAMAMOTO, Kanagawa (JP)

(21) Appl. No.: 14/666,798

(22) Filed: Mar. 24, 2015

(30) Foreign Application Priority Data
Mar. 27, 2014 (JP) 2014-065069

(51) Int. Cl. H04W 72/04; H04W 8/18

(52) U.S. Cl. CPC H04W 72/044; H04W 8/18; H04W 84/12

(57) ABSTRACT

A wireless LAN apparatus including a transmission unit capable of transmitting, through a single channel, a first beacon or a second beacon used for connection of a wireless LAN terminal to the apparatus, and a control unit that when first profile information associated with the first beacon with which the wireless LAN terminal belongs to the apparatus has been changed to second profile information, has the transmission unit transmit the second beacon with which the first profile information is associated.

This application is based upon and claims the benefit of priority from Japanese Patent Application No. 2014-065069, filed on Mar. 27, 2014, the disclosure of which is incorporated herein in its entirety by reference.

### TECHNICAL FIELD

The present invention relates to a wireless LAN apparatus, a wireless LAN terminal and a control method for the apparatus and the terminal.

### BACKGROUND ART

Concerning communication between a wireless LAN access point apparatus and a wireless LAN terminal, in the wireless LAN access point apparatus, when profile information has been changed, contents of a beacon get changed in association with the change of the profile information, and connection with the wireless LAN terminal gets cut. LAN is the abbreviation for local area network. At that time, a user needs to re-connect the wireless LAN terminal to the wireless LAN access point apparatus. In other words, the user needs to visit, the wireless LAN access point apparatus, a person who changed the profile information or the like, acquire the changed profile information, and set the changed profile information in the wireless LAN terminal. Such work is a considerable burden for the user.

Concerning the above-described problem that the connection with the wireless LAN terminal gets cut, Japanese Patent Application Laid-Open Publication No. 2010-178175 describes a technique that even in a case where a wireless LAN terminal does not have a handover function, handover is performed when quality of communication between a wireless LAN access point apparatus and the wireless LAN terminal is degraded.

Specifically, the technique described in Japanese Patent Application Laid-Open Publication No. 2010-178175 is as follows.

The wireless LAN access point apparatus acquires information of communication quality of the wireless LAN terminal belonging to the apparatus. The wireless LAN access point apparatus periodically transmits, to a router apparatus, the acquired information of communication quality, and a basic service set identifier (BSSID) used for communication with the wireless LAN terminal and individually allocated to the wireless LAN terminal under communication. When the router apparatus determines that handover is necessary on the basis of the received information of communication quality, the router apparatus communicates the received BSSID to several related wireless LAN access point apparatuses, and requires to them notification of quality of communication with the wireless LAN terminal concerned. The router apparatus sets, as a handover destination, a wireless LAN access point apparatus that has the best communication quality among those notified. The wireless LAN access point apparatus that is the handover destination uses the communicated BSSID to have the wireless LAN terminal under communication to belong to the apparatus. Every other wireless LAN access point apparatus that has not become the handover destination deletes from itself the communicated BSSID. Since the wireless LAN access point apparatus that is the handover destination has the wireless LAN terminal as a handover target to belong to the apparatus, the wireless LAN terminal does not need to have a handover function. Namely, in the technique described in Japanese Patent Application Laid-Open Publication No. 2010-178175, when quality of communication between a wireless LAN access point apparatus and a wireless LAN terminal is degraded, handover is performed between the wireless LAN access point apparatus and another so that the belonging of the wireless LAN terminal can be maintained.

### SUMMARY

An exemplary object of the invention is to provide a wireless LAN apparatus, a wireless LAN terminal and a control method for the apparatus and the terminal, which can maintain belonging of a wireless LAN terminal to a wireless LAN apparatus without the handover.

An apparatus according to an exemplary aspect of the invention includes a wireless LAN apparatus including a transmission unit capable of transmitting, through a single channel, a first beacon or a second beacon used for connection of a wireless LAN terminal to the apparatus, and a control unit that when first profile information associated with the first beacon with which the wireless LAN terminal belongs to the apparatus has been changed to second profile information, has the transmission unit transmit the second beacon with which the first profile information is associated.

### BRIEF DESCRIPTION OF THE DRAWINGS

Exemplary features and advantages of the present invention will become apparent from the following detailed description when taken with the accompanying drawings in which:

FIG. 1 illustrates a configuration example of a wireless LAN in a first exemplary embodiment of the present invention;

FIG. 2 illustrates a configuration example of a wireless LAN access point apparatus in the first exemplary embodiment of the present invention;

FIG. 3 illustrates an operational flow for a wireless LAN in the first exemplary embodiment of the present invention; and

FIG. 4 illustrates a configuration example of a wireless LAN apparatus in a second exemplary embodiment of the present invention.

### EXEMPLARY EMBODIMENT

A first exemplary embodiment of the present invention will be described with reference to the drawings.

In the present exemplary embodiment, when in a wireless LAN access point apparatus, contents of a beacon get changed in association with change of profile information while a wireless LAN terminal belongs to the wireless LAN access point apparatus, the belonging of the wireless LAN terminal is maintained even though the handover is not performed.

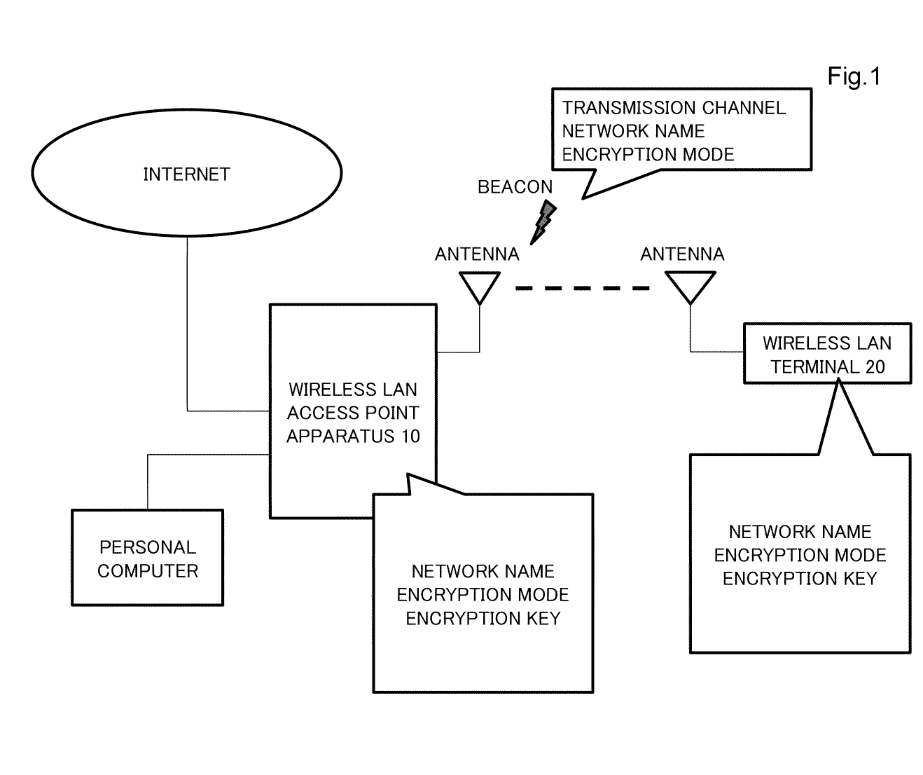

FIG. 1 illustrates a configuration example of a wireless LAN in the present exemplary embodiment. The wireless LAN includes a wireless LAN access point apparatus 10 and a wireless LAN terminal 20.

The wireless LAN access point apparatus 10 transmits a beacon (packets) for making notification of its wireless network so that a wireless LAN terminal can belong to the apparatus. A beacon packet includes information of a transmission channel, and information of a network name and an encryption mode which are a part of profile information. The beacon is transmitted at predetermined time intervals. The wireless LAN access point apparatus 10 can access the Internet (registered trademark). Connected to the wireless LAN access point apparatus 10 is a personal computer or the like capable of setting and changing setting information that includes profile information of the wireless LAN access point apparatus 10.

Set in advance in the wireless LAN terminal 20 is profile information (a network name, an encryption mode, and an encryption key) of a wireless LAN access point apparatus to which connection is desired. The wireless LAN terminal 20 receives a beacon from the wireless LAN access point apparatus, and when profile information included in the beacon is the same as that set in the terminal, the wireless LAN terminal 20 comes to belong to the wireless LAN access point apparatus. The wireless LAN terminal 20 performs connection authentication and transmission and reception of radio packets, with use of the encryption mode and the encryption key set in the terminal. With the wireless LAN terminal 20 continuing receiving a beacon from the wireless LAN access point apparatus at predetermined time intervals, the wireless LAN terminal 20 maintains the belonging to and connection with the wireless LAN access point apparatus. The wireless LAN terminal 20 can access the Internet (registered trademark) via the wireless LAN access point apparatus.

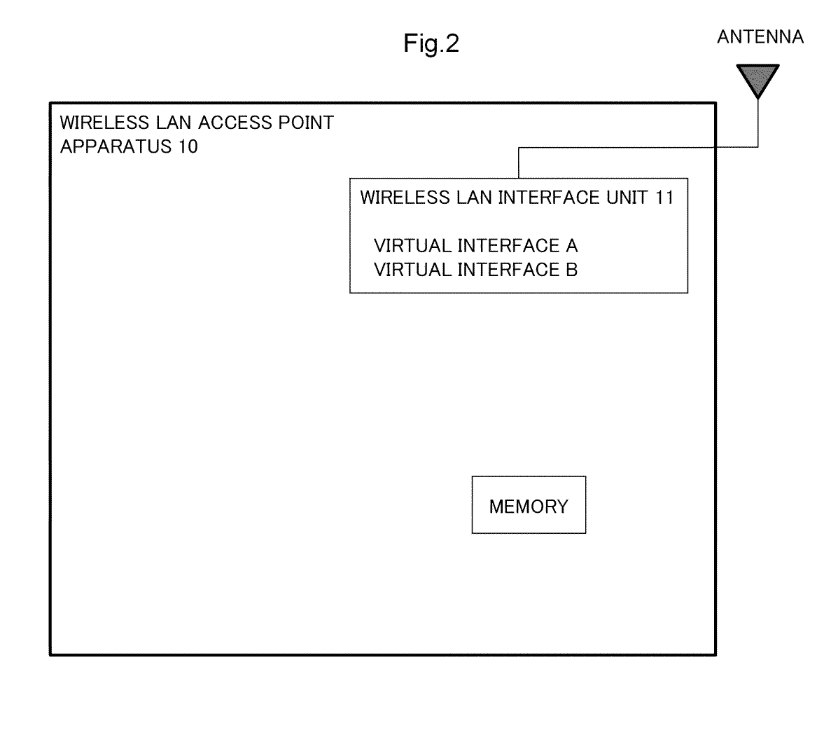

FIG. 2 illustrates a configuration example of the wireless LAN access point apparatus 10. The wireless LAN access point apparatus 10 includes a wireless LAN interface unit 11.

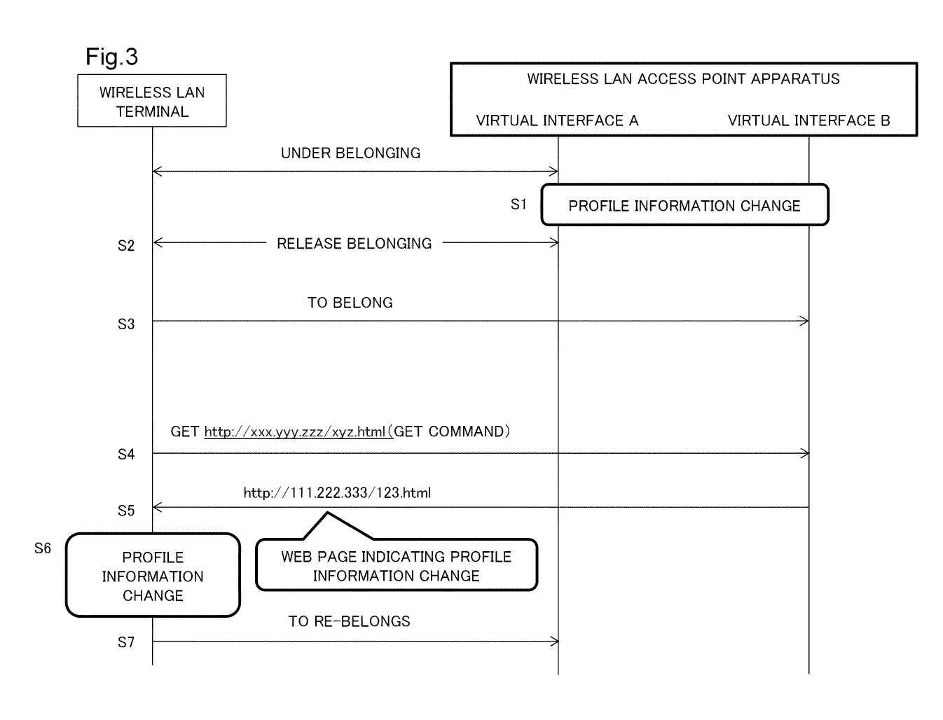

On the basis of the above-described configuration example, operation of the wireless LAN in the present exemplary embodiment will be described with reference to FIG. 1 to FIG. 3. FIG. 3 illustrates an operational flow for the wireless LAN in the present exemplary embodiment.

In the wireless LAN access point apparatus 10, profile information A (a network name a, an encryption mode a, and an encryption key a) is set associated with a virtual interface and a beacon in a memory or the like, in advance by a user. Thereby, the wireless LAN access point apparatus 10 transmits a beacon whose packet includes the network name a and the encryption mode a. Furthermore, in the wireless LAN terminal 20, the profile information A is set in a memory or the like, by a user.

The wireless LAN access point apparatus 10 can transmit a plurality of beacons from a plurality of interfaces virtually provided on a single transmission channel, respectively. The wireless LAN access point apparatus 10 transmits a plurality of beacons associated with a plurality of pieces of profile information, respectively, at different timings, through a single transmission channel. Thereby, the wireless LAN access point apparatus 10 can have wireless LAN terminals set with the respective pieces of profile information to belong to the apparatus.

In the wireless LAN access point apparatus 10, the wireless LAN interface unit 11 is provided with a virtual interface A and a virtual interface B. From the virtual interface A and the virtual interface B, a beacon A and a beacon B are transmitted, respectively. The profile information A is associated with the virtual interface A and the beacon A.

The wireless LAN terminal 20 belongs to the wireless LAN access point apparatus 10, and the wireless LAN access point apparatus 10 transmits, from the virtual interface A, the beacon A whose packet includes the network name a and the encryption mode a. In this state, the virtual interface B is not activated.

On the above-described state, in the wireless LAN access point apparatus 10, the profile information is changed from A (the network name a, the encryption mode a, and the encryption key a) to B (a network name b, a encryption mode b, and a encryption key b), by a user (S1). In response to the change of the profile information, the wireless LAN access point apparatus 10 activates the virtual interface B, and associates, with the virtual interface B and the beacon B, the profile information A associated with the virtual interface A and the beacon A. Accordingly, the wireless LAN access point apparatus 10 transmits, from the virtual interface B, the beacon B whose packet includes the network name a and the encryption mode a. The wireless LAN access point apparatus 10 associates the profile information B with the virtual interface A and the beacon A. Accordingly, the wireless LAN access point apparatus 10 transmits, from the virtual interface A, the beacon A whose packet includes the network name b and the encryption mode b. Since the profile information A is set in the wireless LAN terminal 20 that has received this beacon A, the belonging, with the beacon A, of the wireless LAN terminal 20 to the wireless LAN access point apparatus 10 gets released (S2). The wireless LAN terminal 20 receives the beacon B, and comes to belong to the wireless LAN access point apparatus 10 with the beacon B since the profile information included in the beacon B is the same as that set in the terminal (S3).

In order to further ensure continuity of the transmission of the beacons relevant to the profile information A before and after the change of the above-mentioned profile information, the activation of the virtual interface B and the transmission of the beacon B relevant to the profile information A may be performed before the change is made.

As described above, when in the wireless LAN access point apparatus 10, contents of the beacon get changed in association with the change of the profile information while the wireless LAN terminal 20 belongs to the apparatus, it maintains the belonging of the wireless LAN terminal 20.

Thus, when in the wireless LAN access point apparatus, the contents of the beacon get changed in association with the change of the profile information while the wireless LAN terminal belongs to the wireless LAN access point apparatus, the belonging of the wireless LAN terminal can be maintained even though the handover is not performed.

Description will be made on a method how the change of the profile information is notified to a user while the belonging of the wireless LAN terminal 20 is maintained against the above-described change of the profile information.

When access from the wireless LAN terminal 20 to the wireless LAN access point apparatus 10 or the Internet is performed by a user, the wireless LAN terminal 20 transmits an information acquiring request (GET command) on the hypertext transfer protocol (HTTP) (S4). When the wireless LAN access point apparatus 10 receives the GET command, the wireless LAN access point apparatus 10 once transmits, to the wireless LAN terminal 20, a predetermined web page set in advance in the apparatus no matter what web page the GET command is a request for (S5). The predetermined web page indicates that the profile information has been changed in the wireless LAN access point apparatus 10. The wireless LAN terminal 20 displays the predetermined web page on a display or the like. A user can be notified with the display that the profile information has been changed in the wireless LAN access point apparatus 10, and the user acquires the after-change profile information, and changes the profile information in the wireless LAN terminal 20 to the after-change profile information.

Furthermore, description will be made on a method for changing the profile information in the above-mentioned wireless LAN terminal 20.

By the user notified of the change of the profile information, an acquiring request for the after-change profile information is transmitted from the wireless LAN terminal 20 to the wireless LAN access point apparatus 10. When the wireless LAN access point apparatus 10 receives the acquiring request for the after-change profile information, the wireless LAN access point apparatus 10 transmits the after-change profile information to the wireless LAN terminal 20. The wireless LAN terminal 20 changes the profile information that is set, to the received after-change profile information (S6). The wireless LAN access point apparatus 10 transmits, from the virtual interface A, the beacons A whose packet includes the network name b and the encryption mode b which are included in the after-change profile information. The wireless LAN terminal 20 receives the beacon A, and comes to belong to the wireless LAN access point apparatus 10 with the beacon A since the profile information included in the beacon A is the same as that set in the terminal (S7).

The wireless LAN access point apparatus 10 recognizes, with a media access control (MAC) address or the like, a wireless LAN terminal belonging to a beacon transmitted by the apparatus. As described above, by the change of the profile information of the wireless LAN terminal 20, the wireless LAN terminal 20 comes to re-belong to the former beacon by the above-described change of the profile information of the terminal, from the temporary beacon with which the terminal belongs to the apparatus by the change of the profile information of the wireless LAN access point apparatus 10. When all wireless LAN terminals that belong to the temporary beacon stop belonging to the temporary beacon, stopping transmission of the temporary beacons in the wireless LAN access point apparatus 10 can suppress increase in electric power consumption of the wireless LAN access point apparatus 10.

Next, a second exemplary embodiment of the present invention will be described with reference to the drawing.

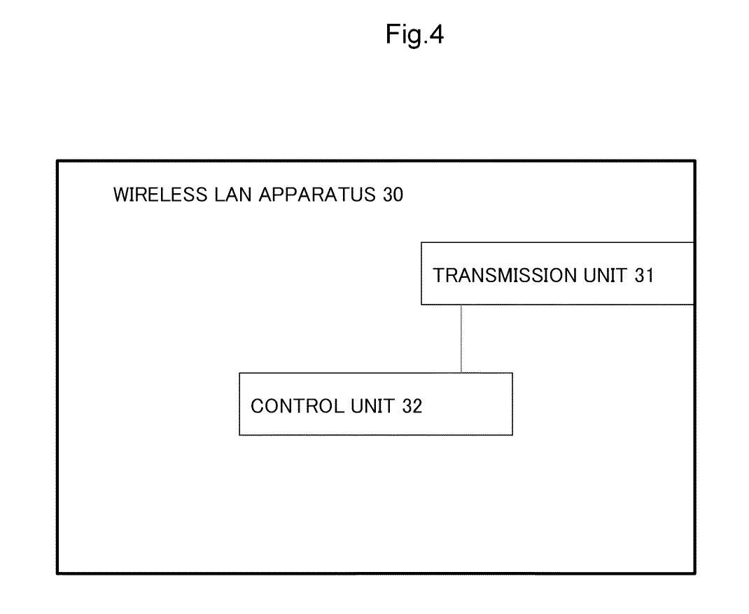

FIG. 4 illustrates a configuration example of a wireless LAN apparatus of the present exemplary embodiment. The wireless LAN apparatus 30 includes a transmission unit 31 and a control unit 32.

The transmission unit 31 can transmit, through a single channel, a first beacon or a second beacon with which a wireless LAN terminal is made to belong to the apparatus.

The control unit 32 associates profile information with a beacon, and has the transmission unit 31 transmit the beacon.

With reference to FIG. 4, operation of the wireless LAN terminal 30 in the present exemplary embodiment will be described.

The wireless LAN apparatus 30 has a wireless LAN terminal to belong to the apparatus, by associating first profile information with the first beacon and has a wireless LAN terminal to belong to the apparatus.

On the above-described state, in the wireless LAN apparatus 30, the first profile information associated with the first beacon with which the wireless LAN terminal belongs to the apparatus has been changed to second profile information, by a user. At the time of the change of the profile information, the control unit 32 of the wireless LAN apparatus 30 associates the first profile information with the second beacon, and has the transmission unit 31 transmit the second beacon.

As described above, when the contents of the beacon are changed in association with the change of the profile information while the wireless LAN terminal belongs to the wireless LAN apparatus 30, the wireless LAN apparatus 30 maintains the belonging of the wireless LAN terminal.

Thus, when in the wireless LAN access point apparatus, the contents of the beacon get changed in association with the change of the profile information while the wireless LAN terminal belongs to the wireless LAN access point apparatus, the belonging of the wireless LAN terminal can be maintained even though the handover is not performed.

In the technique described in Japanese Patent Application Laid-Open Publication No. 2010-178175, when quality of communication between a wireless LAN access point apparatus and a wireless LAN terminal gets degraded, the belonging of the wireless LAN terminal can be maintained. However, the belonging is maintained by handover between the wireless LAN access point apparatus and another. For this reason, in a case where there is not any other wireless LAN access point apparatus to which the wireless LAN terminal can belong near the apparatus, or in other cases, the belonging cannot be maintained. At that time, considerably burdensome work for a user is needed as described above. Namely, in a situation that in the wireless LAN access point apparatus, contents of a beacon get changed in association with change of profile information while the wireless LAN terminal belongs to the wireless LAN access point apparatus, or in other cases, the wireless LAN terminal does not have a handover function, or there is any other wireless LAN access point apparatuses to which belonging is possible. The problem is that in a case that such handover is not performed, the belonging of the wireless LAN terminal cannot be maintained.

An exemplary advantage according to the present invention is as follows. When in a wireless LAN access point apparatus, contents of a beacon get changed in association with change of profile information in a state where a wireless LAN terminal belongs to the wireless LAN access point apparatus, the belonging of the wireless LAN terminal can be maintained even though the handover is not performed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A wireless LAN apparatus comprising:
a transmission unit capable of transmitting, through a single channel, a first beacon or a second beacon used for connection of a wireless local area network (LAN) terminal to the apparatus; and
a control unit that when first profile information associated with the first beacon with which the wireless LAN terminal belongs to the apparatus has been changed to second profile information, has the transmission unit transmit the second beacon with which the first profile information is associated.

2. The wireless LAN apparatus according to claim 1, wherein when the wireless LAN apparatus receives a predetermined signal from a wireless LAN terminal that belongs to the wireless LAN apparatus with the second beacon, the wireless LAN apparatus displays, on the wireless LAN terminal, a predetermined message indicating the change of the profile information.

3. The wireless LAN apparatus according to claim 1, wherein when the wireless LAN apparatus receives an acquiring request for the second profile information from a wireless LAN terminal that belongs to the wireless LAN apparatus with the second beacon, the wireless LAN apparatus transmits the second profile information to the wireless LAN terminal.

4. The wireless LAN apparatus according to claim 1, wherein the transmission of the second beacon starts at a time of the change of the profile information, and stops at a time that all wireless LAN terminals that belong to the apparatus with the second beacon discontinue the belonging to the apparatus with the second beacon.

5. A wireless LAN terminal that when first profile information set associated with a first beacon in a wireless LAN apparatus has been changed to second profile information, comes to belong to the apparatus with a second beacon set associated with the first profile information, transmits an acquiring request for the second profile information to the wireless LAN apparatus, and sets, in the terminal, the second profile information received in response to the acquiring request.

6. A control method for a wireless LAN apparatus, comprising:
transmitting through a single channel a first beacon or a second beacon used for connection of a wireless LAN terminal to the apparatus,
wherein when first profile information associated with the first beacon with which the wireless LAN terminal belongs to the apparatus has been changed to second profile information, transmitting the second beacon with which the first profile information is associated.

7. The control method for the wireless LAN apparatus according to claim 6, wherein when receiving a predetermined signal from a wireless LAN terminal that belongs to the wireless LAN apparatus with the second beacon, displaying, on the wireless LAN terminal, a predetermined message indicating the change of the profile information.

8. The control method for the wireless LAN apparatus according to claim 6, wherein when receiving an acquiring request for the second profile information from a wireless LAN terminal that belongs to the wireless LAN apparatus with the second beacon, transmitting the second profile information to the wireless LAN terminal.

9. The control method for the wireless LAN apparatus according to claim 6, wherein the transmission of the second beacon starts at a time of the change of the profile information, and stops at a time that all wireless LAN terminals belonging to the apparatus with the second beacon discontinue the belonging to the apparatus with the second beacon.

10. A control method for a wireless LAN terminal, comprising: when first profile information set associated with a first beacon in a wireless LAN apparatus has been changed to second profile information, having the terminal belong to the apparatus with a second beacon set associated with the first profile information; transmitting an acquiring request for the second profile information to the wireless LAN apparatus; and setting, in the terminal, the second profile information received in response to the acquiring request.
